(19) United States
(12) Patent Application Publication
(10) Pub. No.: US 2003/0071934 A1
(43) Pub. Date: Apr. 17, 2003

(54) Liquid crystal backlight utilizing side emitting

(75) Inventors: Robert J. Saccomanno, Montville, NJ (US); Kanghua Lu, Waldwick, NJ (US)

Correspondence Address: Honeywell International Inc., Patent Services, Post Office Box 2245, Morristown, NJ, 07962-2245, US

(73) Assignee: Honeywell International Inc., Morristown, NJ

(21) Appl. No.: 10/256,458

(22) Filed: Sep. 26, 2002

Related U.S. Application Data
(60) Provisional application No. 60/328,764, filed on Oct. 12, 2001.

(51) Int. Cl. G02F 1/1335

(52) U.S. Cl. 349/61

(57) ABSTRACT

A dual backlight for a liquid crystal display (LCD) that is both sunlight readable and night vision goggle (NVG) compatible uses one or more side-emitting fiber optic cables as a secondary light source, the side emitting fiber optic cable or cables being interposed between parallel mounted fluorescent lamps.

### RELATED APPLICATIONS This application claims the benefit of U.S. provisional Application Ser. No. 60/328,764, filed Oct. 12, 2001, which is incorporated herein by reference.

### BACKGROUND OF THE INVENTION

1. Technical Field

This invention relates to night vision goggle compatible (NVG) lighting and more particularly to an apparatus for backlighting a liquid crystal display (LCD).

Information displays for military cockpits must attenuate deep red and infrared emissions between wavelengths of approx. 630 nm and 930 nm in order to avoid interference with night vision goggles. When liquid crystal displays (LCD) are utilized as the display device, the source of illumination behind the LCD is traditionally one or more fluorescent lamps; however, they do emit energy which will interfere with the goggles, and so a costly glass filter element must be positioned between the backlight and the LCD.

2. Background Art

Several attempts at combined sunlight readable and night vision goggle (NVG) compatible backlighting are described in the prior art. For example, Farrell (U.S. Pat. No. 5,143,433, Sep. 1, 1992) teaches the use of a plurality of secondary filtered light sources positioned behind the primary light source, through holes in the backlight cavity.

Kalmanash (U.S. Pat. No. 5,211,463, May 18, 1993) discloses that a waveguide may be placed in front of a primary light source and that secondary light sources including one or more filtered lamps can illuminate an input to the waveguide. The Kalamanash waveguide is transparent so that the primary illumination passes through the waveguide during the daylight mode. The waveguide has one or more extraction features, which direct the light from the waveguide input towards a liquid crystal display (LCD). These extraction features are configured to have minimal efficiency degradation on the day mode.

Abileah I (U.S. Pat. No. 5,262,880, Nov. 16, 1993) uses a large area night vision goggle (NVG) filter over a single lamp.

Habing et al, (U.S. Pat. No. 5,661,578, Aug. 20, 1997) teaches that one or more secondary filtered collimated light sources can be positioned at the bottom of the sidewall of a backlight cavity. The collimated light then gets scattered throughout the cavity providing uniform illumination for a night mode. The secondary light sources are configured to be as small as practical to avoid negative effects to the day mode illumination.

Abileah II (U.S. Pat. No. 6,111,622, Aug. 29, 2000) teaches a liquid crystal display with a dual backlight, namely a large area electroluminescent (EL) lamp behind a fluorescent bulb.

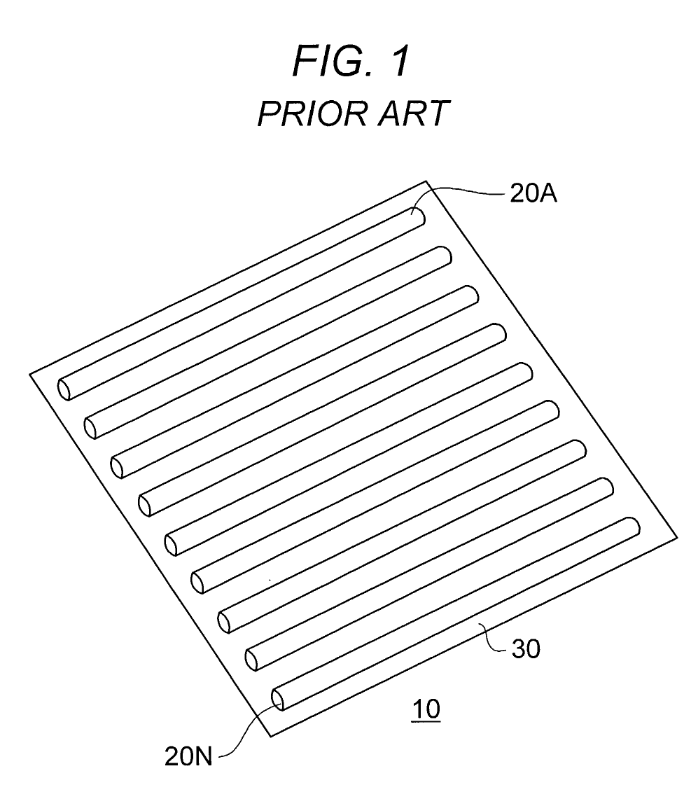

A typical prior art backlight, that is not night vision goggle (NVG) compatible, for a liquid crystal display (LCD) is depicted in FIG. 1. Note that there are associated optical films and sidewalls that are not shown in FIG. 1. This typical array-type backlight assembly 10 is composed of an array of fluorescent ‘stick lamps’ 20A . . . 20N mounted on a reflective mounting plate 30.

There is thus a long felt need in the art for an inexpensive sunlight-readable and NVG-compatible liquid crystal display backlight.

### SUMMARY OF THE INVENTION

The present invention comprises a dual backlight for a liquid crystal display (LCD) including primary light that allows the LCD to be viewed in direct sunlight conditions and separate secondary light that allows the LCD to be viewed under night vision goggles (NVG).

In accordance with our invention, the secondary light is provided by side-emitting fiber elements that are positioned between stick fluorescent lamps that provide the primary light. These side-emitting fiber elements radiate light in a manner similar to stick lamps. In accordance with an aspect of our invention, a light source energizes the side-emitting fiber elements through an optical filter connected to each of the side emitting fiber elements while a suitable power source is electrically connected to the fluorescent lamps. Advantageously, when the side-emitting fiber elements are not illuminated, they only minimally absorb light from the fluorescent lamps due to their material composition. A single power source may be employed alternately to energize the optical fiber light source and the fluorescent lamp power source.

It is well known that light radiation in the red to infrared spectrum can interfere with the proper operation of night vision goggles. Accordingly, a large area infrared filter has been employed to cover the entire display surface or backlight of a liquid crystal display to make that display NVG-compatible. However, due to their large area, these filters are expensive. In accordance with one aspect of our invention, only a very small area optical filter is connected in the optical light path from the energizing light source to the optical fiber elements interposed between the stick fluorescent lamps, the single small optical filter assuring that the light exiting from the side-emitting optical fiber elements is NVG-compatible.

In accordance with one embodiment of our invention, the optical fiber elements comprise individual side-emitting optical fibers that are positioned between adjacent fluorescent lamps. Alternatively, in accordance with another embodiment of our invention, the optical fiber a single optical fiber is sinuously wound between the fluorescent lamps.

### BRIEF DESCRIPTION OF DRAWINGS

### Brief Description of the Several Views of the Drawing

FIG. 1 illustrates a prior art backlight suitable for use with an active matrix liquid crystal display.

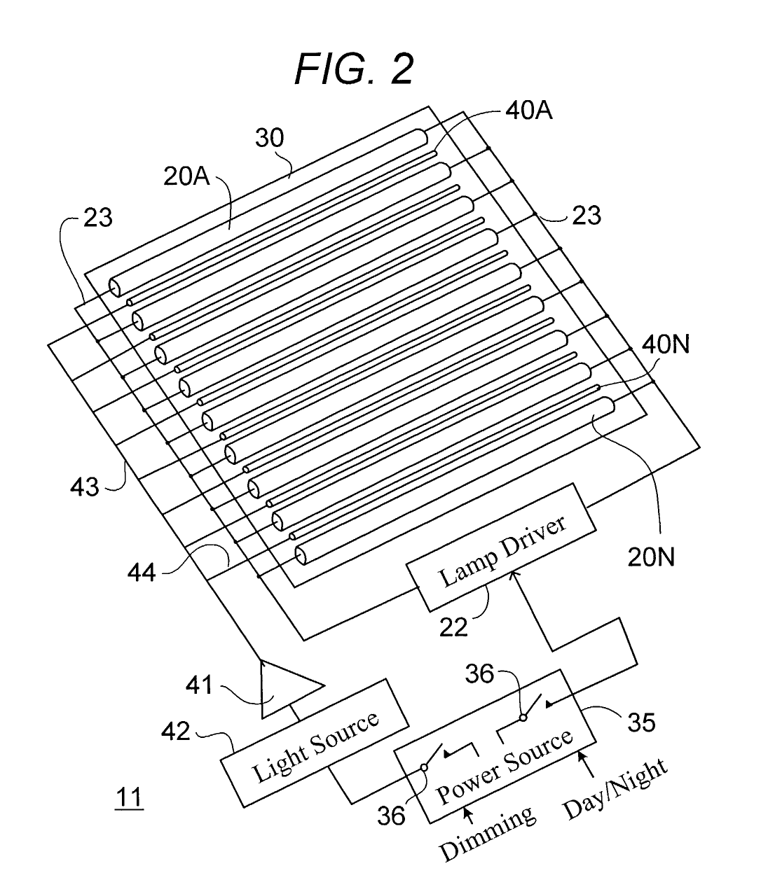

FIG. 2 illustrates an inventive backlight suitable for use with an active matrix liquid crystal display and including multiple side-emitting optical fibers in accordance with one illustrative embodiment of our invention.

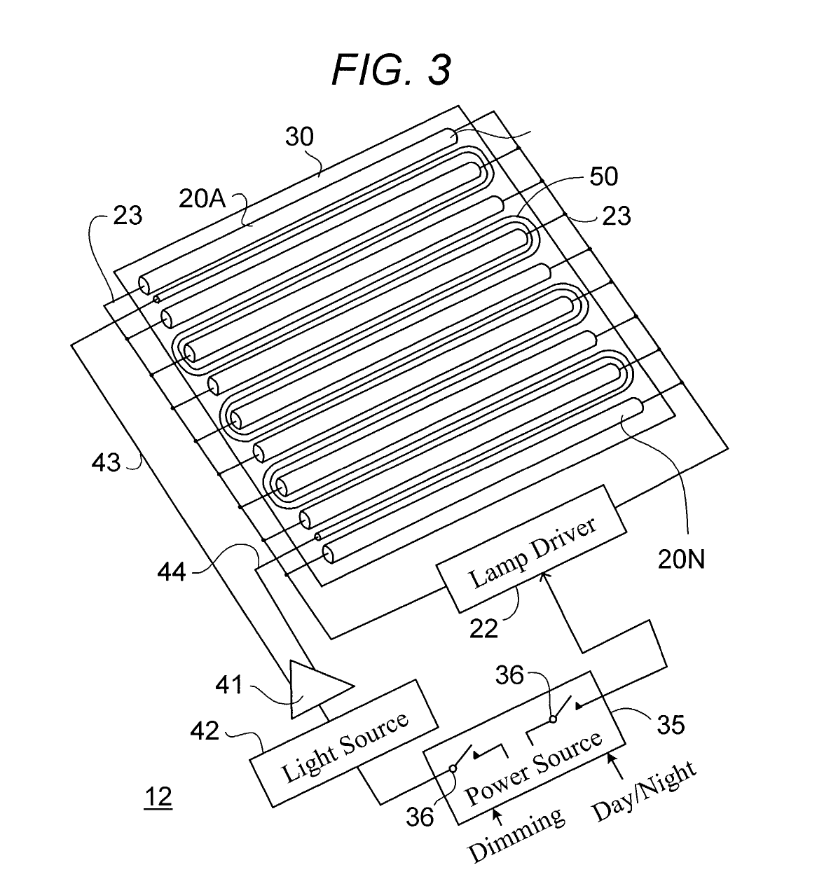

FIG. 3 illustrates an inventive backlight suitable for use with an active matrix liquid crystal display and including a single continuous side-emitting optical fiber in accordance with a second illustrative embodiment of our invention.

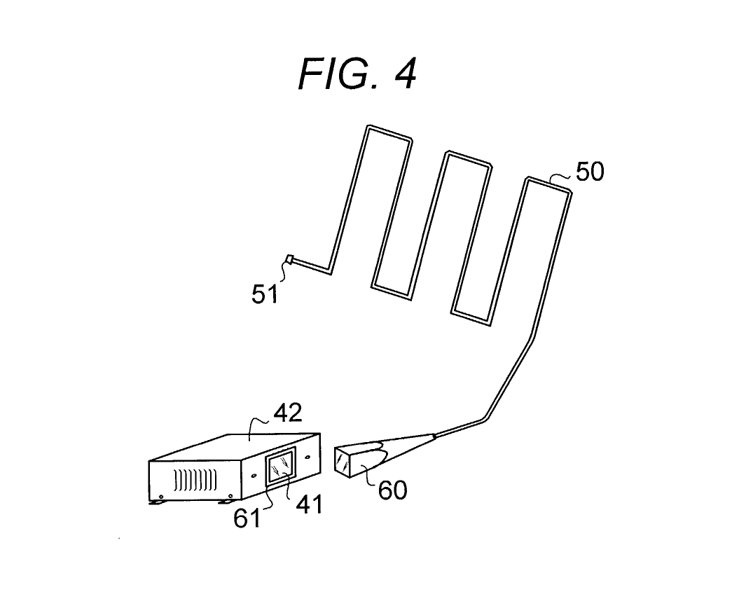

FIG. 4 depicts a light source including an optical filter and a single continuous side-emitting optical fiber suitable for use in the embodiment of our invention shown in FIG. 3.

### DETAILED DESCRIPTION OF THE INVENTION

### Mode(s) for Carrying Out the Invention

Referring to FIG. 2, in a first embodiment of our invention, a dual backlight assembly 11 includes both the primary light source comprising a plurality of unfiltered fluorescent lamps 20A . . . 20N and the secondary light source comprising a plurality of side emitting fiber optic cables 40A . . . 40N, such as are available from Poly-Optical Products Inc. These side-emitting fiber optic cables, 40A . . . 40N, are driven by an alternate light source that is filtered prior to the entrance of each cable. For a ‘day’ operational mode, the array of small diameter, unfiltered, ‘stick’ fluorescent lamps 20A . . . 20N are used to provide illumination. Typically these lamps are a few millimeters in diameter, and are spaced apart to achieve the desired luminous efficacy and luminous uniformity. For example, a 6″×8″ (150 mm×200 mm) display may employ eight stick fluorescent lamps, where each stick fluorescent lamp has a diameter of approximately 3 mm and with the stick lamps evenly spaced apart. Suitable stick fluorescent lamps, for example, may be available from Harison Toshiba Lighting Corporation.

A lamp driver 22 is electrically connected by leads 23 to the fluorescent stick lamps 20. Suitable lamp drivers may be purchased, for example, from Endicott Research Group, Inc. The lamps may be driven in parallel from the lamp driver 22, be all in series with the lamp driver 22, or be paired so that some are in series and some are in parallel. The individual side emitting optic cables 40 are optically driven by light from a light source 42, through an optical filter 41, such as filters available from Wamco Inc., and an optical cable 43. The light source 42 may be for example, an incandescent lamp or one or more light emitting diodes (LED). The optical cable 43 is connected to one side of each of the side emitting fiber optic cables 40. The other end of the side emitting optical cables 40 may serve to absorb the light transmitted to it, have a reflective coating to return light through the cables, or have another external optical cable connected thereto for returning the light to the light source 42.

In certain embodiments, auxiliary light pipes, such as those from Bivar, Inc., are used to couple light from individual light emitting diodes (LED), within the light source 42, to one or more optical fibers within the side emitting optical cables 40. Alternatively, an optical morphing element 60, as shown in FIG. 4, can be used to couple the light source 42 to the side emitting optical cables 40.

In addition, both the lamp driver 22 for the fluorescent lamps 20 and the light source 42 for the fiber optic cables 40 may advantageously be driven by a common power source 35 which internally has electrical switches 36 provided for alternately powering either the fluorescent stick lamps 20 or the light source 42, which in turn optically drives the fiber optic cables 40. Alternatively, power can be simultaneously applied to both light sources; the lamp driver 22 and the light source 42. In a preferred embodiment, power is applied to both light sources simultaneously, with an easy-on/easy-off function incorporated to provide a smooth transition between day and night operational modes.

Illumination is provided during a ‘night’ operational mode from side-emitting fiber optic cables 40A . . . 40N, where each fiber optic cable is positioned between adjacent fluorescent stick lamps. In this one embodiment of our invention, the side-emitting fiber optic cables 40A . . . 40N are all routed to a single lamp or light source 42, with a suitable NVG-compatible optical filter 41 situated between the lamp and the side-emitting fiber optic cables 40A . . . 40N. During the night operational mode, the fluorescent stick lamps 20A . . . 20N are extinguished, and the side emitting fibers 40A . . . 40N provide the illumination for the LCD, by operation of the electrical switches 36 within the power source 35. In a further embodiment of our invention, the side-emitting fiber optic cables 40A . . . 40N have substantially the same diameter as the fluorescent stick lamps 20A . . . 20N.

Referring to FIG. 3, in a second embodiment of our invention, the dual backlight assembly 12 includes both the primary light source comprising a plurality of unfiltered fluorescent lamps 20A . . . 20N and the secondary light source comprising a single continuous side-emitting optical fiber 50. This single continuous side-emitting optical fiber 50 is driven at both ends by the alternate light source 42, where the alternate light source is filtered at the entrance to each end of the cable. As described previously, for a ‘day’ operational mode, the array of stick fluorescent lamps 20A . . . 20N are used to provide illumination. For a ‘night’ operational mode, the single continuous side-emitting optical fiber 50 is used to provide illumination. Alternately, as shown in FIG. 4, only one end of the single continuous side-emitting optical fiber 50 may be connected to the light source 42, the other end 51 having a reflective coating for returning light back through the optical fiber 50.

Advantageously, since the exit aperture 61 of the light source 42 has a relatively small surface area, the light exiting the light source can be effectively filtered using a filter 41, such as a night vision goggle compatible filter with a small surface area. This small area optical filter 41 is significantly less expensive than a large area filter that has been used to cover the entire display surface, such as six (6) by eight (8) inches.

### Alternate Embodiments

Alternate embodiments may be devised without departing from the spirit or the scope of the invention. For example, a set of three side-emitting optical cables, each providing a primary color such as red, green, or blue, can be used instead of the white light side-emitting fiber optic cables as described above. Additionally, the optical filter 41 can also provide a color matching function so that the user perceives the desired color saturation during both day and night modes.

What is claimed is:

1. A liquid crystal display backlight comprising
a reflective plate;
a plurality of fluorescent lamps positioned proximal to said reflective plate;
a plurality of side emitting optical fiber elements positioned proximal to said reflective plate and adjacent each of said fluorescent lamps;
a light source for energizing said side emitting optical fiber elements; and
an optical filter positioned between said light source and said side emitting optical fiber elements and forming a portion of an optical path therebetween.

2. The liquid crystal display backlight in accordance with claim 1 wherein said fluorescent lamps are fluorescent stick lamps which are positioned in parallel proximal to said mounting plate and said side emitting optical fiber elements are positioned between adjacent pairs of said elongated fluorescent lamps.

3. The liquid crystal display backlight in accordance with claim 2 wherein said side emitting optical fiber elements comprise a plurality of individual fiber optic cables each receiving light exiting said optical filter.

4. The liquid crystal display backlight in accordance with claim 2 wherein said side emitting optical fiber elements comprise a single optical fiber sinuously interposed between said adjacent pairs of said fluorescent stick lamps, said optical fiber receiving light exiting said optical filter.

5. The liquid crystal display backlight in accordance with claim 4 wherein said optical filter is a night vision compatible optical filter.

6. The liquid crystal display backlight in accordance with claim 1 further comprising:
switching means for alternately energizing said fluorescent lamps for day operation and said side emitting optical fiber elements for night operation.

7. The liquid crystal display backlight in accordance with claim 1 wherein said fluorescent stick lamps and said side emitting optical fiber elements have substantially the same diameter.

8. The liquid crystal display backlight in accordance with claim 1 further comprising:
a power source that simultaneously excites both the fluorescent stick lamps and the light source at least during a transition from a day operational mode to a night operational mode.
